(19) United States
(12) Patent Application Publication
(10) Pub. No.: US 2016/0299253 A1
(43) Pub. Date: Oct. 13, 2016

(54) BATTERY-POWERED DOWNHOLE TOOLS WITH A TIMER

(71) Applicant: HALLIBURTON ENERGY SERVICES, INC., Houston, TX (US)

(72) Inventors: Xiaohong ZHANG, Singapore (SG); Guosheng JIN, Singapore (SG); Alberto QUINTERO, Singapore (SG); Roy TAN, Singapore (SG)

(73) Assignee: Halliburton Energy Services, Inc., Houston, TX (US)

(21) Appl. No.: 14/777,530

(22) PCT Filed: Jul. 30, 2014
(86) PCT No.: PCT/US2014/048778

§ 371 Date: Sep. 16, 2015

(51) Int. Cl. G01V 99/00

(52) U.S. Cl. CPC G01V 99/00

(57) ABSTRACT

An example electronics module for a downhole tool includes a power source that provides an operating voltage and a processor communicably coupled to the power source to receive the operating voltage. A timer is communicably coupled to the power source and the processor and includes a real-time clock, a diode, and a capacitor. The real-time clock is powered by a primary power supply provided by the operating voltage and a backup power supply provided by the capacitor as charged through the diode. The real-time clock is powered by the primary power supply during normal operation and powered by the backup power supply when the primary power supply fails.

### BACKGROUND

The present disclosure is related to downhole tools used in the oil and gas industry and, more particularly, to battery-powered downhole tools that rely on a timer.

In the oil and gas industry, downhole tools are often run into wellbores to obtain measurements of one or more downhole parameters, such as temperature, pressure, etc. For instance, measurement while drilling (MWD) and logging while drilling (LWD) tools are often used to collect data about downhole parameters in a wellbore while the wellbore is being drilled. In other cases, downhole tools may be conveyed into completed wellbores via wireline or slickline to obtain such measurements. The collected data can be used to make various interpretations about conditions downhole and, in the event drilling is taking place, to adjust a current drilling operation.

In some cases, the collected data can be sent to the surface in real-time while the downhole tool is operating within the wellbore. In other cases, however, there is no communication link between the downhole tool and the surface. In such cases, the collected data is transferred to and stored in an on-board storage device that includes one or more non-volatile memories. The stored data may subsequently be downloaded from the storage device when the downhole tool is retrieved to the surface.

When downhole tools are battery-operated and timer-based devices, operation of the downhole tools may be controlled by a battery-powered timer. The timer and battery combination may also operate or otherwise actuate one or more motors associated with the downhole tools. In some cases, the timer is an electronic timer that resides within a microcontroller and is usually pre-programmed on the surface just before the downhole tool is run downhole.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic diagram of a wellbore system that can employ the principles of the present disclosure.

FIG. 2 is a schematic diagram of an exemplary electronics module.

FIG. 3 is a schematic diagram of exemplary circuitry of the timer of FIG. 2.

### DETAILED DESCRIPTION

The present disclosure is related to downhole tools used in the oil and gas industry and, more particularly, to battery-powered downhole tools that rely on a timer.

The embodiments described herein provide a backup power source for a timer used in a downhole tool. Upon the expiration of a predetermined time limit programmed into the timer, a signal may be sent to actuate the downhole tool such that the downhole tool performs a designed downhole operation. In the event that a primary power source for the timer fails or otherwise provides intermittent power that would otherwise reset the timer, the backup power source may be activated to provide a continuous power source. As a result, the timer is able to continue to operate as programmed without losing its pre-programmed timing information. Without such backup power, if the downhole tool's power is disrupted or down for more than a few hundred milliseconds all information programmed into the timer is lost and the downhole tool must be pulled out of the well to access and re-program the timer at surface. As can be appreciated, this process can be quite costly and time-consuming.

Advantageously, the backup power source may be provided using a low-leakage capacitor, which provides a low-current backup mode to power the timer. Another advantage of the present disclosure is the ability to reduce the power consumption of the downhole tool by placing a processor in the downhole tool in sleep or standby mode when not in use. Since the time is continuously kept by the timer and its backup power source, the processor may be periodically placed in a power saving mode to reduce power consumption.

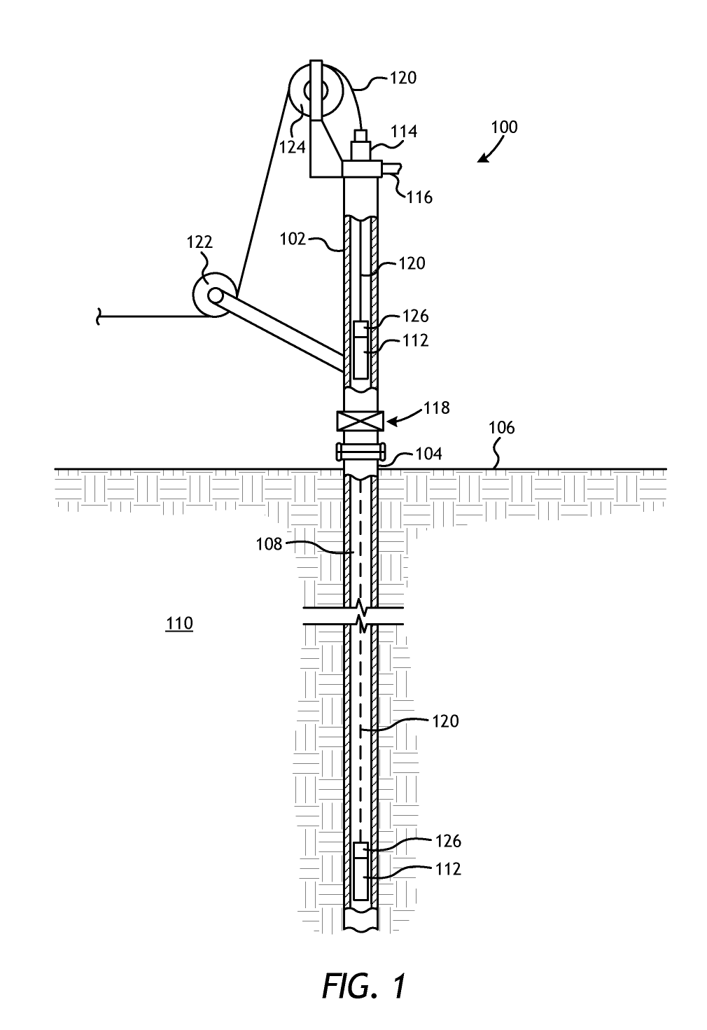

Referring to FIG. 1, illustrated is an exemplary wellbore system 100 that may embody or otherwise employ one or more principles of the present disclosure, according to one or more embodiments. In the illustrated embodiment, the system 100 may include a lubricator 102 operatively coupled to a wellhead 104 installed at the surface 106 of a wellbore 108. As illustrated, the wellbore 108 extends from the surface 106 and penetrates a subterranean formation 110 for the purpose of recovering hydrocarbons therefrom. While shown as extending vertically from the surface 106 in FIG. 1, it will be appreciated that the wellbore 108 may equally be deviated, horizontal, and/or curved over at least some portions of the wellbore 108, without departing from the scope of the disclosure. The wellbore 108 may be cased, open hole, contain tubing, and/or may generally be characterized as a hole in the ground having a variety of shapes and/or geometries as are known to those of skill in the art. Furthermore, it will be appreciated that embodiments disclosed herein may be employed in surface (e.g., land-based) or subsea wells.

The lubricator 102 may be coupled to the wellhead 104 and additional components that are not expressly shown, such as a tubing head and/or adapter, may be positioned between the lubricator 102 and the wellhead 104. The lubricator 102 may be an elongate, high-pressure pipe or tubular configured to provide a means for introducing a downhole tool 112 into the wellbore 108 in order to undertake one or more downhole operations within the wellbore 108. The top of the lubricator 102 may include a stuffing box 114 coupled to a high-pressure grease-injection line 116 used to introduce grease or another type of sealant into the stuffing box 114 in order to generate a seal. The lower part of the lubricator 102 may include one or more valves 118, such as an isolating valve, a swab valve, etc.

A conveyance 120 may be extended into the lubricator 102 via the stuffing box 114 and attached at one end to the downhole tool 112. The conveyance 120 may generally provide a means for transporting the downhole tool 112 into the wellbore 108 such that the desired downhole operations can be undertaken. In some embodiments, the conveyance 120 may be a wireline or slickline, as known to those skilled in the art, and may omit any energy conductors extending between the downhole tool 112 and the surface 106. Accordingly, the conveyance 120 may be unable to place the downhole tool 112 in direct communication with the surface 106. The conveyance 120 is generally fed to the lubricator 102 from a spool or drum (not shown) and through one or more sheaves 122, 124 before being introduced into the stuffing box 114 which provides a seal about the conveyance 120 as it slides into the lubricator 102.

Those skilled in the art will readily recognize that the arrangement and various components of the lubricator 102 and the wellhead 104 are described merely for illustrative purposes and therefore should not be considered limiting to the present disclosure. Rather, many variations of the lubricator 102 and the wellhead 104 may be had, without departing from the scope of the disclosure. Moreover, it is noted that the principles of the present disclosure are equally applicable to other types of oil and gas installations and rigs, such as drilling rigs, workover rigs, offshore platforms, subsea wellheads, etc. Accordingly, in other applications, the conveyance 120 may alternatively be, but is not limited to, drill pipe, production tubing, coiled tubing, and any combination thereof.

The downhole tool 112 may include an electronics module 126 communicably coupled (e.g., wired or wirelessly) to any of a variety of actuating devices and/or contrivances used to actuate or operate the downhole tool 112 in performing its designed downhole operation. As described in more detail below, the electronics module 126 may include, among other components, a timer and a power source that provides electrical power to the timer. Prior to introducing the downhole tool 112 into the wellbore 108, the electronics module 126 may be accessed by a well operator and the timer may be pre-programmed with one or more predetermined time limits or time thresholds. As used herein, “accessing” the electronics module 126 refers to communication with the electronics module 126, such as communicating with the timer or other components of the electronics module 126. Upon the expiration of such predetermined time limits, the timer may signal or otherwise trigger actuation of the downhole tool 112.

Accordingly, the downhole tool 112 may be any battery-powered tool or device that generally relies on a timer to control its actions in undertaking its downhole operation(s). The downhole tool 112 may include, but is not limited to, a sampler, a sensing instrument, a data collection device and/or instrument, a completion tool, a drilling tool, a stimulation tool, an evaluation tool, a safety tool, an abandonment tool, a packer, a bridge plug, a setting tool, a perforation gun, a casing cutter, a flow control device, a measure while drilling (MWD) tool, a logging while drilling (LWD) tool, a drill bit, a reamer, a stimulation tool, a fracturing tool, a production tool, combinations thereof, and the like.

While being conveyed downhole, or otherwise during operation, the downhole tool 112 may be subjected to large acceleration forces, such as vibration or thrust forces resulting from assorted downhole conditions or operations. Upon assuming such acceleration forces, the power provided to the timer may be disrupted temporarily. More particularly, spring-loaded connectors (not shown) that couple the power source to the timer may become intermittently disconnected when the downhole tool 112 experiences large acceleration forces. Such intermittent power disruptions to the timer may result in the timer resetting or otherwise losing its pre-programmed timing information.

According to embodiments of the present disclosure, however, a backup power supply may be included in the electronics module 126 to provide continuous power to the timer in the event there are any power disruptions, such as those resulting from an acceleration force assumed by the electronics module 126. As described below, the backup power supply may be configured to provide power to the timer for several minutes following a power failure or intermittent power supply provided by the power source, and thereby allows the timer to continue to operate as programmed without losing its pre-programmed timing information.

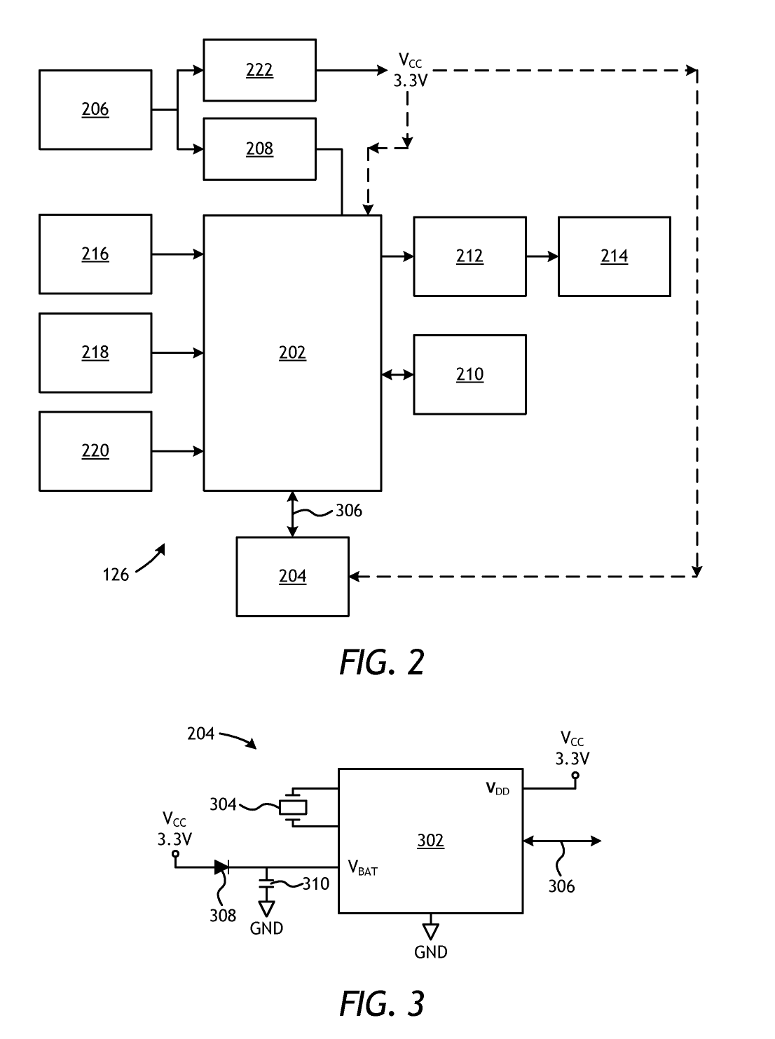

Referring now to FIG. 2, with continued reference to FIG. 1, illustrated is a schematic diagram of the electronics module 126, according to one or more embodiments of the present disclosure. As illustrated, the electronics module 126 may include a processor 202, a timer 204, and a power source 206. The power source 206 may be or otherwise include one or more batteries, such as alkaline or lithium-ion batteries. The power source 206 may be configured to provide electrical power to the processor 202 and the timer 204. In some embodiments, the power source 206 may be directly coupled to the processor 202. In other embodiments, however, a power gauge 208 may interpose the power source 206 and the processor 202 to monitor the voltage and current of the power source 206. If the voltage of the power source 206 falls below a certain threshold, the power gauge 208 may be configured to inform the processor 202 so that the processor 202 can respond correspondingly, such as by stopping all operations and powering down all peripheral devices and/or mechanisms.

The processor 202 may be configured to control the operation of the downhole tool 112 (FIG. 1). The processor 202 can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. The processor 202 may include or otherwise be communicably coupled to a non-volatile memory 210 used to store data. The non-volatile memory 210 may include, for example, random access memory (RAM), flash memory, read only memory (ROM), ferroelectric RAM (F-RAM), programmable read only memory (PROM), electrically erasable programmable read only memory (EEPROM), or any other like suitable storage device or medium.

Executable sequences or steps described herein can be implemented with one or more sequences of code contained in the memory 210. In some embodiments, such code can be read into the memory 210 from another machine-readable medium. Execution of the sequences of instructions contained in the memory 210 can cause the processor 202 to perform the process steps described herein. In some embodiments, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to the processor 202 for execution. A machine-readable medium can take on many forms including, for example, non-volatile media (Flash Memory, ROM, PROM, EEPROM, etc.), volatile media (RAM, FRAM, etc.), and transmission media. Transmission media can include, for example, coaxial cables, wire, fiber optics, and wires that form a bus.

The processor 202 may also be communicably coupled to a motor driver 212 used to control one or more associated motors 214 (one shown). The motor 214 may be operably coupled to one or more mechanisms or devices (not shown) that may be manipulated by the motor 214 in undertaking the designed downhole operation(s) of the downhole tool 112 (FIG. 1). For instance, in at least one embodiment, the motor 214 may be configured to actuate or operate a sampling tool (not shown) associated with the downhole tool 112 and used to obtain a sample of wellbore fluids from within the wellbore 108 (FIG. 1). In other cases, the motor 214 might execute various types of mechanical work, such as opening and closing valves, moving completion sleeves around, installing/removal of plugs and/or performing drilling activities.

In some embodiments, the electronics module 126 may also include circuitry for a variety of sensors and/or gauges including, but not limited to, a temperature sensor 216, a pressure sensor 218, and an accelerometer 220. Data obtained or otherwise measured by the temperature sensor 216, the pressure sensor 218, and/or the accelerometer 220 may be provided to the processor 202 for computing. In some embodiments, for instance, particular or predetermined measurements obtained by one or more of the temperature sensor 216, the pressure sensor 218, and/or the accelerometer 220 and processed by the processor 202 may trigger actuation of the downhole tool 112 (FIG. 1). In other embodiments, measurements obtained by one or more of the temperature sensor 216, the pressure sensor 218, and/or the accelerometer 220 may cause the processor 202 to wake from a sleep or standby mode, as described in more detail below. In yet other embodiments, measurements obtained by the temperature sensor 216, the pressure sensor 218, and/or the accelerometer 220 may be stored in the non-volatile memory 210 to be retrieved upon returning the downhole tool 112 to the surface 106 (FIG. 1).

The electronics module 126 may further include a switch-mode DC/DC converter 222 communicably coupled to the power source 206 and configured to convert high voltage (e.g., greater than about 10 volts) derived from the power source 206 to a low operating voltage V_{CC} (e.g., about 3.3 volts). The switch-mode DC/DC converter 222 may be coupled to the processor 202 and the timer 204 to convey the operating voltage V_{CC} thereto and thereby power the electronics of the downhole tool 112 (FIG. 1).

Referring now to FIG. 3, with continued reference to FIG. 2, illustrated is a schematic diagram of the circuitry of the timer 204, according to one or more embodiments. As illustrated, the timer 204 may include a real-time clock 302 regulated by a crystal oscillator 304. In at least one embodiment, the frequency of the crystal oscillator 304 is 32.768 kHz, but could alternatively operate at other frequencies. The real-time clock 302 may be configured to provide time information to the processor 202 via a serial interface 306, such as an inter-integrated circuit (I2C) or a serial peripheral interface (SPI bus). As briefly mentioned above, the timer 204 may be pre-programmed with one or more predetermined time limits or time thresholds. Upon expiration of such predetermined time limits, as kept by the real-time clock 302, a corresponding signal may be sent to the processor 202 via the serial interface 306. The processor 202 may receive and process such signals and, in some embodiments, trigger actuation of the downhole tool 112 (FIG. 1) in response thereto.

The timer 204 may include and otherwise be fed by two power supplies, a primary power supply V_{DD} and a backup power supply V_{BAT}. Each of the primary and backup power supplies V_{DD}, V_{BAT} may be powered by the operating voltage V_{CC} provided by the power source 206 (FIG. 2) via the switch-mode DC/DC converter 222 (FIG. 2). During normal operation of the timer 204 and the downhole tool 112 (FIG. 1), the real-time clock 302 may be powered by the primary power supply V_{DD}. In the event the primary power supply V_{DD} fails, however, the backup power supply V_{BAT} may be automatically activated to maintain a steady supply of the operating voltage V_{CC} to the real-time clock 302.

More particularly, the timer 204 may further include a diode 308 and a capacitor 310 configured to provide and otherwise facilitate the backup power supply V_{BAT} for the real-time clock 302. The diode 308 and the capacitor 310 may be communicably coupled to the operating voltage V_{CC} provided by the power source 206 (FIG. 2) via the switch-mode DC/DC converter 222 (FIG. 2). The diode 308 may be a low-leakage diode, and the capacitor 310 may be a low-leakage capacitor. During normal operation of the timer 204, the capacitor 310 may be slowly charged through the diode 308 to at or near the level of the operating voltage V_{CC} (i.e., about 3.3V).

Having the capacitor 310 charged to the operating voltage V_{CC} may allow the real-time clock 302 to be powered by the backup power supply V_{BAT} in the event the operating voltage V_{CC} and, therefore, the primary power supply V_{DD} supplied to the timer 204 is lost. As briefly described above, such power losses may be attributed to the downhole tool 112 being subjected to an acceleration force or other downhole anomaly that intermittently disconnects the power source 206 from the timer 204. In the event the primary power supply V_{DD} to the timer 204 is lost, even for a short period of time (e.g., a few hundred milliseconds), the backup power supply V_{BAT} may be automatically activated and commence drawing the required operating voltage V_{CC} from the capacitor 310 to operate the real-time clock 302. For example, when the voltage provided by V_{DD} falls below the voltage provided by V_{BAT}, the internal control logic of real-time clock 302 is configured to automatically switch the power supply to V_{BAT}. Consequently, the real-time clock 302 may be provided with a continuous supply of the operating voltage V_{CC} and any predetermined time limits or time thresholds pre-programmed into the real-time clock 302 will not be lost.

Upon restoration of the primary power supply V_{DD}, the operating voltage V_{CC} drawn from the capacitor 310 ceases and is instead provided via the primary power supply V_{DD}. With the primary power supply V_{DD} again providing the required operating voltage V_{CC}, the capacitor 310 may again be slowly charged through the diode 308 to at or near the level of the operating voltage V_{CC} (i.e., about 3.3V) and, therefore, prepare itself for another intermittent power loss.

Since the diode 308 and the capacitor 310 are low-leakage components, the backup power supply V_{BAT} may comprise a low-current mode for the timer 204 where the current consumption of the real-time clock 302 is low as compared with current consumption during normal operation. In this low-current mode, the time will still be kept by the real-time clock 302 until V_{BAT} drops to a certain threshold voltage Vₜₕ. The time before V_{BAT} drops to the threshold voltage Vₜₕ may be determined by the following:

$$T = \frac{C 1 \times ( {V}_{C 1} - {V}_{th} )}{{I}_{BAT} + {I}_{CL} + {I}_{DL}} \qquad Equation ( 1 )$$

where T is the battery life of the capacitor 310, C1 is the capacitance of the capacitor 310, V_{C1} is the voltage on the capacitor 310 before discharging (e.g., around 3.3V), Vₜₕ is the minimum voltage required by the real-time clock 302 to keep time, I_{BAT} is the current consumption of the real-time clock 302 in low-current backup mode, I_{CL} is the leakage current of the capacitor 310, and I_{DL} is the reverse leakage current of the diode 308. Normally Vₜₕ is around 1.5 volts and I_{BAT} is below 1.0 μA. If the diode 308 and the capacitor 310 are properly selected, I_{DL} can be below 1.0 μA and I_{CL} can also be below 1.0 μA.

According to Equation (1), and in an embodiment where C1 of the capacitor 310 is 220 μF, for example, then the time before V_{BAT} drops to the threshold voltage Vₜₕ may be as follows:

$$\frac{220 uF \times ( 3.3 V - 1.5 V )}{3 uA} = 132 seconds$$

In accordance with this embodiment, and in the event the primary power supply V_{DD} to the timer 204 is lost, the backup power supply V_{BAT} drawn from the capacitor 310 may be able to power and operate the real-time clock 302 for about 132 seconds. Since common instances of intermittent power in downhole tools 112 (FIG. 1) only last for a few hundred milliseconds, the backup power supply V_{BAT} may, therefore, be sufficient to maintain the timer 204 in working order such that any predetermined time limits or time thresholds pre-programmed into the real-time clock 302 will not be lost.

Referring again to FIG. 2, in some embodiments, the processor 210 may be selectively placed in a sleep mode or standby mode to conserve power drawn from the power source 206. More particularly, since the time is continuously kept by the timer 204 (e.g., the real-time clock 302 of FIG. 3), and is protected by a backup power mode that uses power stored in the capacitor 310 (FIG. 3), the processor 202 may be periodically and/or selectively placed in sleep mode to reduce power consumption from the power source 206.

The processor 202 may be removed from the sleep mode via a variety of actions. For example, in some embodiments, the timer 204 may be programmed to send a “wake up” signal to the processor 202 at a predetermined time so that the processor 202 may undertake a certain task (e.g., actuating the downhole tool 112). In other embodiments, the processor 202 may be removed from sleep mode once a predetermined temperature, pressure, or acceleration is detected by the temperature sensor 216, the pressure sensor 218, and the accelerometer 220, respectively. Upon detecting the predetermined temperature, pressure, and/or acceleration, the “wake up” signal may be sent to the processor 202 so that the processor 202 may again draw power from the power source 206 and undertake a certain task (e.g., actuating the downhole tool 112). As will be appreciated, selectively powering down the processor 202 both at scheduled times and at unscheduled times when nothing significant is happening may assist in energy conservation.

Those skilled in the art will readily appreciate that the embodiments disclosed herein may be useful in all logging while drilling (LWD), wireline, and cased-hole applications known to those skilled in the art, where the associated downhole tools may be battery-operated and rely on a timer to control the various actions of the downhole tools.

Embodiments disclosed herein include:

A. An electronics module for a downhole tool that includes a power source that provides an operating voltage, a processor communicably coupled to the power source to receive the operating voltage, and a timer communicably coupled to the power source and the processor and including a real-time clock, a diode, and a capacitor, wherein the real-time clock is powered by a primary power supply provided by the operating voltage and a backup power supply provided by the capacitor as charged through the diode, and wherein the real-time clock is powered by the primary power supply during normal operation and powered by the backup power supply when the primary power supply fails.

B. A system that includes a downhole tool extendable within a wellbore on a conveyance, and an electronics module positioned on the downhole tool and including a power source that provides an operating voltage, a processor communicably coupled to the power source, and a timer communicably coupled to the power source and the processor, the timer including a real-time clock, a diode, and a capacitor, wherein the real-time clock is powered by a primary power supply provided by the operating voltage and a backup power supply provided by the capacitor as charged through the diode, and wherein the real-time clock is powered by the primary power supply during normal operation and powered by the backup power supply when the primary power supply fails.

C. A method that includes accessing an electronics module of a downhole tool, the electronics module including a power source that provides an operating voltage, a processor communicably coupled to the power source, and a timer communicably coupled to the power source and the processor, wherein the timer includes a real-time clock, a diode, and a capacitor, programming the timer with one or more predetermined time limits, introducing the downhole tool into a wellbore on a conveyance, powering the real-time clock with a primary power supply provided by the operating voltage, and powering the real-time clock with a backup power supply when the primary power supply fails, the backup power supply being provided by the capacitor as charged through the diode.

Each of embodiments A, B, and C may have one or more of the following additional elements in any combination: Element 1: further comprising a non-volatile memory communicably coupled to the processor and at least one of a temperature sensor communicably coupled to the processor and operable to obtain temperature measurements, a pressure sensor communicably coupled to the processor and operable to obtain pressure measurements, and an accelerometer communicably coupled to the processor and operable to obtain acceleration measurements. Element 2: further comprising a motor driver communicably coupled to the processor, and one or more motors communicably coupled to the motor driver, wherein the processor controls the one or more motors via the motor driver and the one or more motors actuate a downhole tool. Element 3: further comprising a switch-mode DC/DC converter communicably coupled to the power source and providing the operating voltage to the processor and the timer. Element 4: wherein the diode is a low-leakage diode and the capacitor is a low-leakage capacitor. Element 5: wherein the capacitor is charged through the diode from a connection to the operating voltage. Element 6: wherein the capacitor is charged to at or near a level of the operating voltage. Element 7: wherein the timer is pre-programmed with one or more predetermined time limits.

Element 8: wherein the conveyance comprises at least one of a wireline, a slickline, drill pipe, production tubing, coiled tubing, and any combination thereof. Element 9: wherein the downhole tool is a tool selected from the group consisting of a sampler, a sensing instrument, a data collection device and/or instrument, a completion tool, a drilling tool, a stimulation tool, an evaluation tool, a safety tool, an abandonment tool, a packer, a bridge plug, a setting tool, a perforation gun, a casing cutter, a flow control device, a measure while drilling (MWD) tool, a logging while drilling (LWD) tool, a drill bit, a reamer, a stimulation tool, a fracturing tool, a production tool, and any combination thereof. Element 10: further comprising a non-volatile memory communicably coupled to the processor and at least one of a temperature sensor communicably coupled to the processor and operable to obtain temperature measurements, a pressure sensor communicably coupled to the processor and operable to obtain pressure measurements, and an accelerometer communicably coupled to the processor and operable to obtain acceleration measurements. Element 11: further comprising a motor driver communicably coupled to the processor, and one or more motors communicably coupled to the motor driver, wherein the processor controls the one or more motors via the motor driver and the one or more motors actuate the downhole tool. Element 12: wherein the diode is a low-leakage diode and the capacitor is a low-leakage capacitor. Element 13: wherein the capacitor is charged through the diode from a connection to the operating voltage, and wherein the capacitor is charged to at or near a level of the operating voltage. Element 14: wherein the timer is pre-programmed with one or more predetermined time limits and, wherein, upon expiration of the one or more predetermined time limits, a signal is sent to the processor and triggers actuation of the downhole tool.

Element 15: undertaking a downhole operation upon expiration of the one or more predetermined time limits. Element 16: further comprising charging the capacitor through the diode via a connection to the operating voltage, and charging the capacitor to at or near a level of the operating voltage. Element 17: further comprising receiving the operating voltage with the processor to operate the processor, and selectively placing the processor in a sleep mode to reduce power consumption. Element 18: further comprising removing the processor from the sleep mode upon expiration of the one or more predetermined time limits. Element 19: wherein the electronics module further includes at least one of temperature sensor communicably coupled to the processor, a pressure sensor communicably coupled to the processor, and an accelerometer communicably coupled to the processor, the method further comprising removing the processor from the sleep mode upon detecting one of a predetermined temperature, a predetermined pressure, or a predetermined acceleration with the temperature sensor, the pressure sensor, and the accelerometer, respectively.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An electronics module for a downhole tool, comprising:
a power source that provides an operating voltage;
a processor communicably coupled to the power source to receive the operating voltage; and
a timer communicably coupled to the power source and the processor and including a real-time clock, a diode, and a capacitor, wherein the real-time clock is powered by a primary power supply provided by the operating voltage and a backup power supply provided by the capacitor as charged through the diode, and
wherein the real-time clock is powered by the primary power supply during normal operation and powered by the backup power supply when the primary power supply fails.

2. The electronics module of claim 1, further comprising a non-volatile memory communicably coupled to the processor and at least one of:
a temperature sensor communicably coupled to the processor and operable to obtain temperature measurements;
a pressure sensor communicably coupled to the processor and operable to obtain pressure measurements; and
an accelerometer communicably coupled to the processor and operable to obtain acceleration measurements.

3. The electronics module of claim 1, further comprising:
a motor driver communicably coupled to the processor; and
one or more motors communicably coupled to the motor driver, wherein the processor controls the one or more motors via the motor driver and the one or more motors actuate a downhole tool.

4. The electronics module of claim 1, further comprising a switch-mode DC/DC converter communicably coupled to the power source and providing the operating voltage to the processor and the timer.

5. The electronics module of claim 1, wherein the diode is a low-leakage diode and the capacitor is a low-leakage capacitor.

6. The electronics module of claim 1, wherein the capacitor is charged through the diode from a connection to the operating voltage.

7. The electronics module of claim 8, wherein the capacitor is charged to at or near a level of the operating voltage.

8. The electronics module of claim 1, wherein the timer is pre-programmed with one or more predetermined time limits.

9. A system, comprising:
a downhole tool extendable within a wellbore on a conveyance; and
an electronics module positioned on the downhole tool and including a power source that provides an operating voltage, a processor communicably coupled to the power source, and a timer communicably coupled to the power source and the processor, the timer including a real-time clock, a diode, and a capacitor,
wherein the real-time clock is powered by a primary power supply provided by the operating voltage and a backup power supply provided by the capacitor as charged through the diode, and
wherein the real-time clock is powered by the primary power supply during normal operation and powered by the backup power supply when the primary power supply fails.

10. The system of claim 9, wherein the conveyance comprises at least one of a wireline, a slickline, drill pipe, production tubing, coiled tubing, and any combination thereof.

11. The system of claim 9, wherein the downhole tool is a tool selected from the group consisting of a sampler, a sensing instrument, a data collection device and/or instrument, a completion tool, a drilling tool, a stimulation tool, an evaluation tool, a safety tool, an abandonment tool, a packer, a bridge plug, a setting tool, a perforation gun, a casing cutter, a flow control device, a measure while drilling (MWD) tool, a logging while drilling (LWD) tool, a drill bit, a reamer, a stimulation tool, a fracturing tool, a production tool, and any combination thereof.

12. The system of claim 9, further comprising a non-volatile memory communicably coupled to the processor and at least one of:
a temperature sensor communicably coupled to the processor and operable to obtain temperature measurements;
a pressure sensor communicably coupled to the processor and operable to obtain pressure measurements; and
an accelerometer communicably coupled to the processor and operable to obtain acceleration measurements.

13. The system of claim 9, further comprising:
a motor driver communicably coupled to the processor; and
one or more motors communicably coupled to the motor driver, wherein the processor controls the one or more motors via the motor driver and the one or more motors actuate the downhole tool.

14. The system of claim 9, wherein the diode is a low-leakage diode and the capacitor is a low-leakage capacitor.

15. The system of claim 9, wherein the capacitor is charged through the diode from a connection to the operating voltage, and wherein the capacitor is charged to at or near a level of the operating voltage.

16. The system of claim 9, wherein the timer is pre-programmed with one or more predetermined time limits and, wherein, upon expiration of the one or more predetermined time limits, a signal is sent to the processor and triggers actuation of the downhole tool.

17. A method, comprising:
accessing an electronics module of a downhole tool, the electronics module including a power source that provides an operating voltage, a processor communicably coupled to the power source, and a timer communicably coupled to the power source and the processor, wherein the timer includes a real-time clock, a diode, and a capacitor;
programming the timer with one or more predetermined time limits;
introducing the downhole tool into a wellbore on a conveyance;
powering the real-time clock with a primary power supply provided by the operating voltage; and
powering the real-time clock with a backup power supply when the primary power supply fails, the backup power supply being provided by the capacitor as charged through the diode.

18. The method of claim 17, undertaking a downhole operation upon expiration of the one or more predetermined time limits.

19. The method of claim 17, further comprising:
charging the capacitor through the diode via a connection to the operating voltage; and
charging the capacitor to at or near a level of the operating voltage.

20. The method of claim 17, further comprising:
receiving the operating voltage with the processor to operate the processor; and
selectively placing the processor in a sleep mode to reduce power consumption.

21. The method of claim 20, further comprising removing the processor from the sleep mode upon expiration of the one or more predetermined time limits.

22. The method of claim 20, wherein the electronics module further includes at least one of temperature sensor communicably coupled to the processor, a pressure sensor communicably coupled to the processor, and an accelerometer communicably coupled to the processor, the method further comprising:
removing the processor from the sleep mode upon detecting one of a predetermined temperature, a predetermined pressure, or a predetermined acceleration with the temperature sensor, the pressure sensor, and the accelerometer, respectively.
